(19) United States
(12) Patent Application Publication
(10) Pub. No.: US 2011/0270476 A1
(43) Pub. Date: Nov. 3, 2011

(54) ADAPTER DEVICE AND METHOD FOR CHARGING A VEHICLE

(75) Inventors: Jakob Doppler, Gallnenkirchen (AT); Alois Ferscha, Vienna (AT); Marquart Franz, Sauerlach (DE); Manfred Hechinger, Linz (AT); Marcos Jansch Dos Santos Rocha, Munchen (DE); Doris Zachhuber, Wolfern (AT); Andreas Zeidler, Munchen (DE)

(73) Assignee: SIEMENS AKTIENGESELLSCHAFT, MÜNCHEN (DE)

(21) Appl. No.: 13/003,463

(22) PCT Filed: May 6, 2009
(86) PCT No.: PCT/EP2009/055456

§ 371 Date: Mar. 11, 2011

(30) Foreign Application Priority Data
Jul. 8, 2008 (DE) 10 2008 032 135.4

(51) Int. Cl. G06F 17/00; H02J 7/00

(52) U.S. Cl. 701/22; 320/107; 320/109

(57) ABSTRACT

An adapter apparatus has an interface for detecting internal vehicle operation data containing factors which report driving habits according to lifestyle, and an interface for detecting details related to the fluctuation of energy prices. The adapter apparatus further has a device for detecting and planning requirements, the device being configured for deducing an energy requirement profile using the vehicle operation data and for producing a future requirement plan based on at least one of the named factors. The device further being suitable for deducing the duration and frequency of vehicle down times by incorporating the requirement plan and having a charging optimizing device which is configured for comparing the vehicle down times with the energy price fluctuation. Details for producing a vehicle charging plan which is optimized for time and/or price and is based on the results of the comparison. The apparatus further having a charging control unit which is configured for charging the vehicle from an energy store in a manner controlled by the charging plan.

The invention relates to an adapter device and a method for charging a vehicle as claimed in claim 1 and claim 8 respectively.

As a result of increasing vehicle use on the one hand and the anticipated shortage of fossil fuels on the other, regulatory interventions in the automobile market are essential. The mandatory reduction of CO₂ emissions is forcing manufacturers to consider low-polluting and more efficient propulsion technologies. This requirement is also enshrined in the European Energy Efficiency Directive and in the Action Plan. The Commission wants, in its own words, to create markets for cleaner, smarter, safer and more energy efficient vehicles and increase public awareness to that effect.

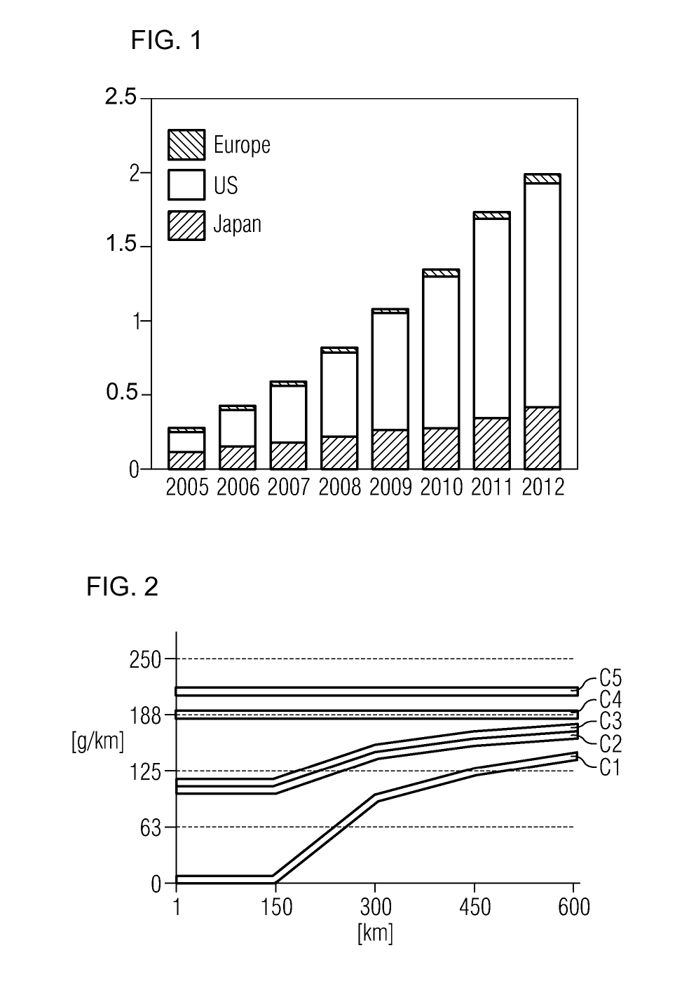

On the consumer side, fossil fuel cost trends are boosting demand for and acceptance of cheaper alternatives to conventional internal combustion engine powered vehicles. These trends are confirmed by current sales statistics for hybrid vehicles which are regarded by many experts as precursors to all-electric vehicles, as shown in FIG. 1. The figure shows a bar chart indicating the number of electric motors (in millions of units) sold in Europe, the USA and Japan over the years 2005 to 2007, and the expected trend up to 2012.

In addition to the reduced energy requirement, which may as a matter of preference also be covered by renewable energy sources, this technology currently provides a considerable reduction in emissions particularly on short journeys. The plug-in hybrid concept now even promises emission-free operation through the use of the electric motor alone for short periods, as illustrated in FIG. 2. This figure shows the CO₂ emissions in g/km of a hybrid (Kangoo) and of a plug-in hybrid vehicle (Cleanova) over a distance traveled in km. The individual curves C1 (Curve 1) to C5 (Curve 5) apply to Cleanova II 2004 (33% ao—wind 20 g), Cleanova II 2004 (33% ao—mix 650 g), Cleanova II 2004 (66% ao—mix 650 g), Kangoo 2006 (66% ao) and Kangoo 2006 (33% ao) in the sequence of said curves.

However, electrically powered vehicles require repeated charging of the electrical energy store, the battery. Said charging takes place during vehicle idle times, but in an unscheduled manner at these times and mainly only when a full charge is required. Such a procedure is inefficient against the background of current price movements.

The object of the present invention is therefore to provide an optimized method for charging the energy store of a vehicle which is particularly simple to implement as well as being reliable and cost-efficient.

This object is achieved in device terms using an adapter device having an interface for acquiring internal vehicle operating data including factors which indicate lifestyle-dependent driving habits, and an interface for acquiring information about energy price movements; a requirement identification and planning unit which is designed to deduce an energy requirement profile from the vehicle operating data and to create a future requirement plan on the basis of at least one of said factors, and which is additionally designed to deduce the duration and frequency of idle times of the vehicle using the requirement plan; a charging optimization unit designed to compare the vehicle idle times with the information about energy price movements and to create a time- and/or price-optimized charging plan for the vehicle on the basis of the comparison results, and a charging control unit designed for charging the vehicle's energy store in a manner controlled by the charging plan.

The invention is based on the assumption that vehicle usage is subject to unexpected events as well as recurring patterns of use which can be ascertained from the vehicle operating data and statistically analyzed. On this basis, an essential aspect of the device according to the invention is that factors of lifestyle-dependent driving habits are brought in and examined for optimizing the battery charging process and therefore reducing energy and costs against the background of current electricity price movements. In principle, said device is not limited to an electrical application, but can be used in conjunction with all energy sources suitable for powering vehicles, even including gas, for example.

Although both theoretical and practical approaches as well as prototype implementations for individual sub-aspects of the problem outlined exist, with the inventive combination of requirement determination and charging optimization allied to cost-efficient energy trading mechanisms, this is the first time this problem has been solved.

Aside from the main feature of energy consumption per time unit and/or distance traveled, there are a number of other factors which can be incorporated into the modeling of driving habits. These include:
(i) Time factors such as operating times and idle times of the vehicle, journey start and end times, journey duration and number of journeys per day.
(ii) Routing and height profile of the individual drives.
(iii) Purpose of the journey such as e.g. the daily drive to work, leisure travel and private errands such as shopping.
(iv) Trip-chaining patterns as recurring sequences of known drives and locations of the vehicle.
(v) Environmental factors—e.g. weather conditions and temperature which affect battery life and driving conditions.
(vi) External vehicle context information such as e.g. traffic flow and holdups and calendar information of mainly one-off appointments of the vehicle keeper.

Current traffic census statistics indicate that significant usage patterns can be found for motorized individual travel. For example, 51% of the Austrian population make use of a private vehicle as the preferred means of transport for weekday short-distance travel. For an average number of 3.7 journeys of 13.5 km in rural areas, more than 50% of journeys particularly between 2.5 km and 50 km are made by car, the journey time being on average 23 minutes. This data shows that most journeys are short haul, coinciding with the above mentioned advantages of electrically powered vehicles.

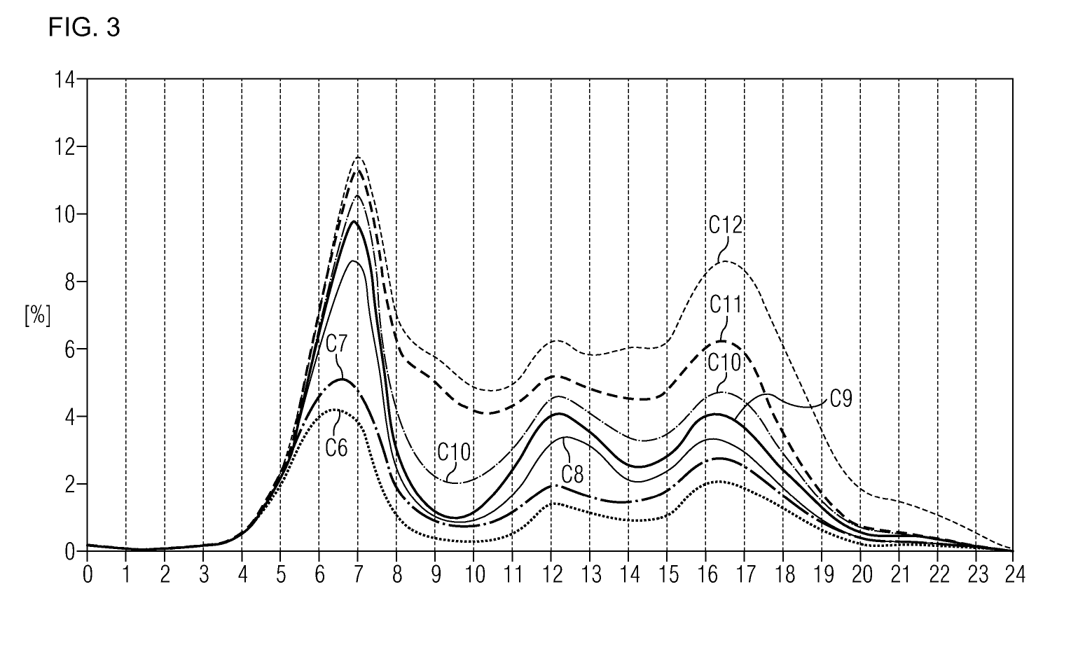

Clear conclusions can also be drawn in respect of the purpose of the journey and the periodicity of travel times. FIG. 3 shows weekday variations over time of the start times of journeys per day as a function of respective travel purposes in cumulative curves C6 to C12. These correspond to journeys to work, official or business journeys, education/training trips, taking or picking up people, private errands, shopping trips and leisure travel in the sequence of said curves. While only 4% of all car journeys are made without a known purpose, the remaining 96% (52% work-related journeys, 28% private errands and shopping, and 16% leisure travel) are made up of known usage patterns. Particularly in connection with the start time of journeys by trip purpose, good information about daily usage patterns can be provided. While work and education/training related journeys are strongly represented percentage-wise in morning travel and the time around 16:30, the curves for business journeys between 9:00 and 10:00 and leisure beginning at 15:00 to 20:00 are significant.

Further developments of the device according to the invention are set forth in claims 2 to 7.

Accordingly, a particularly high prediction quality for the future use of a vehicle is achieved by providing an interface for acquiring context information describing in more detail the current situation of the vehicle and having an effect on consumption, particularly profile data of a vehicle keeper and/or traffic information and/or weather information, and for which the requirement identification and planning unit is additionally designed to deduce an energy requirement profile from said context information. By means of these additional inputs, the information base from which current and therefore potentially future driving habits are deduced is broadened, thereby increasing the recognition and prediction quality for the use of the vehicle.

Particularly simple data coupling of the adapter device is achieved by designing at least one of the interfaces for wireless acquisition of data and/or inputs and/or information, thereby obviating the need for corresponding plug and socket connections which the vehicle user also does not need to establish.

Alternatively or at the same time, a memory unit for storing information about energy price movements can be provided which is kept up to date e.g. by means of regular software updates, thereby making the adapter device independent of the connection to online trading platforms.

On the one hand, the adapter device can be implemented as an external adapter between an energy source and the energy store of the vehicle, thereby making said adapter highly versatile. Thus, it can be used e.g. for charging a plurality of, and different, vehicles, and it does not have to be purchased again when buying a another vehicle.

On the other hand, however, it may be preferable if the adapter device is implemented as an integral part of the vehicle. Then it would not need to be additionally purchased and carried separately.

In an advantageous use of the adapter device according to the invention it is lastly provided that it is used to recognize vehicle usage patterns, particularly for recognizing driving habits and/or a driving style for calculating insurance models.

The above object is achieved by a method comprising the following steps: acquiring and storing internal vehicle operating data comprising factors indicative of lifestyle-dependent driving habits; deducing an energy requirement profile from the vehicle operating data and creating a future requirement plan which is generated having regard to at least one of said factors; using the requirement plan to deduce the duration and frequency of idle times of the vehicle; acquiring energy price movements and comparing the idle times of the vehicle with said energy price movements, and creating a time- and/or price-optimized charging plan for the vehicle on the basis of the comparison result.

A key aspect of the method according to the invention is in its simple structure which on the one hand ensures a high degree of reliability and, on the other, is particularly easy and inexpensive to implement e.g. in software, hardware or firmware.

Further developments of the method according to the invention are set forth in claims 9 to 17 and relate particularly to how the above described factors of lifestyle-dependent driving habits are incorporated therein.

In an advantageous embodiment of the said method it is first provided that a requirement plan for the vehicle is generated by determining daily travel times and average journey duration from a characteristic curve of an actual energy consumption of past journeys. This provides a simple model from which the usual times of use of a vehicle can be deduced, and from which, conversely, its idle times may be inferred. For this purpose, the actual energy consumption is continuously recorded and stored for analysis.

In another advantageous embodiment of the method it is provided that, to generate the requirement plan for the vehicle, daily operating times and/or route data are additionally used. This means that a time classification of the journey by start time, end time and duration is possible, thereby creating a basis for more precise prediction of the future usage of the vehicle.

In another advantageous embodiment it is additionally provided that a requirement plan for the vehicle is generated by acquiring the positions of the vehicle and deducing spatial trip-chaining patterns therefrom which indicate daily recurring destinations and their sequential order, thereby recording the routing and any journey interruptions such as intermediate stops and lengthy parking, which allows more accurate identification of idle times.

The method can also be made more precise by additionally using external vehicle context information which describes the current situation of the vehicle in more detail and which has an effect on consumption, particularly profile data of a vehicle keeper and/or traffic information and/or weather information to generate a requirement plan. Also acquired thereby are influences indirectly affecting the energy requirement of the vehicle via a possible speed in each case.

In order to be able to ensure reliable operation of the vehicle even in the event of unexpected changes in driving habits, it is advantageous to inform the user of a vehicle about unscheduled charging options if charge is low due to unforeseeable journeys.

Particularly reliable operation of the vehicle is also ensured by acquiring the energy price movements by interrogating an internet-based energy trading platform. By means of the up-to-the-minute data, an optimum energy quantity can, for example, be determined at the simultaneously most favorable price, or more precisely the charging start and end time at which the vehicle is idle can be specified.

Alternatively or simultaneously it can also be provided that the energy price movements are acquired by periodically installing a software update. This in turn offers the advantage that determining the quantity of energy and/or price as described above does not require a corresponding online connection to an energy trading platform. The method therefore operates independently of that means of supplying price data.

Particularly simple charging can be ensured by activating an power feed to the vehicle that is controlled in a charging plan dependent manner as soon as the vehicle is connected to an energy source. The vehicle user does not then need to worry about any activation steps and/or pre-settings for charging. This allows quick connection to an energy source and increases acceptance of the method.

To generate requirement plans, pattern recognition and/or machine learning and/or artificial intelligence methods are preferably implemented which are already well known and easily implementable, and require no additional development outlay.

The present invention will now be explained in greater detail on the basis of two inventive adapter devices with reference to the accompanying drawings. Parts that are identical or have an identical effect are denoted by the same reference characters:

FIG. 1 shows a bar chart with the known and forecast sales figures for electric motors in Europe, the USA and Japan in millions of units, plotted over the years 2005 to 2012;

FIG. 2 shows a graph with characteristic curves of CO₂ emissions in g/km of a hybrid (Kangoo) and a plug-in hybrid vehicle (Cleanova), plotted over the respective distance traveled in km;

FIG. 3 shows a graph with weekday characteristic curves of start times of journeys as a function of travel purpose in cumulative curves;

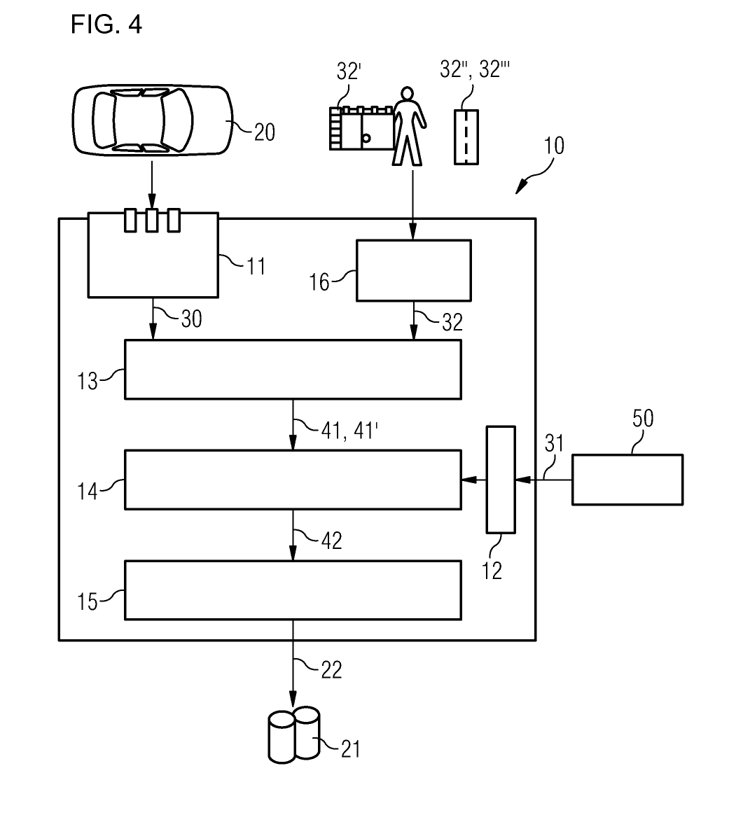

FIG. 4 shows an inventive adapter device illustrating the basic principle of the method according to the invention;

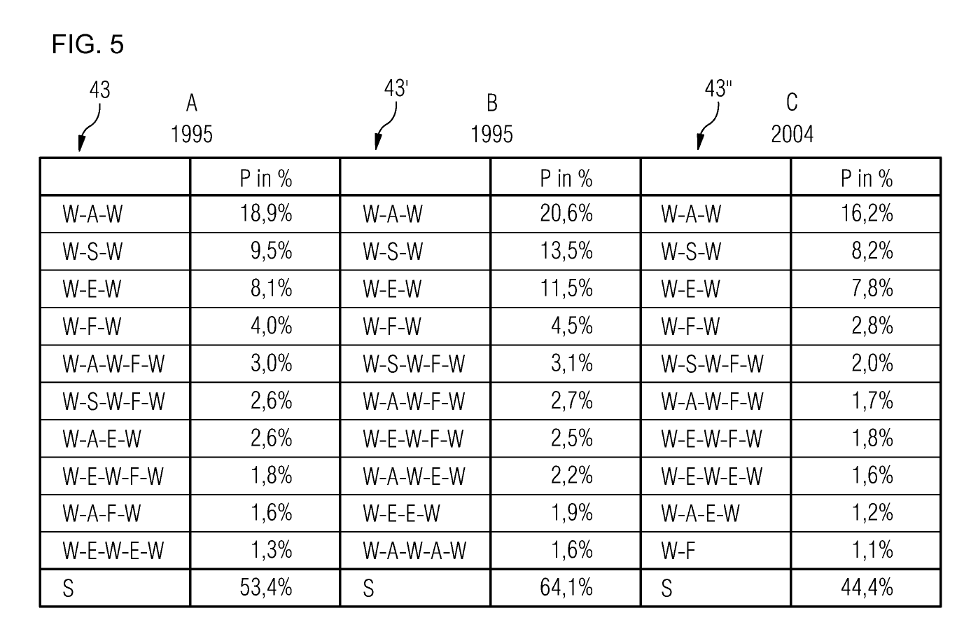

FIG. 5 shows the most frequent day-to-day trip-chaining patterns in Vienna, in the urban fringes of Vienna 1995 and in the city of Salzburg 2004;

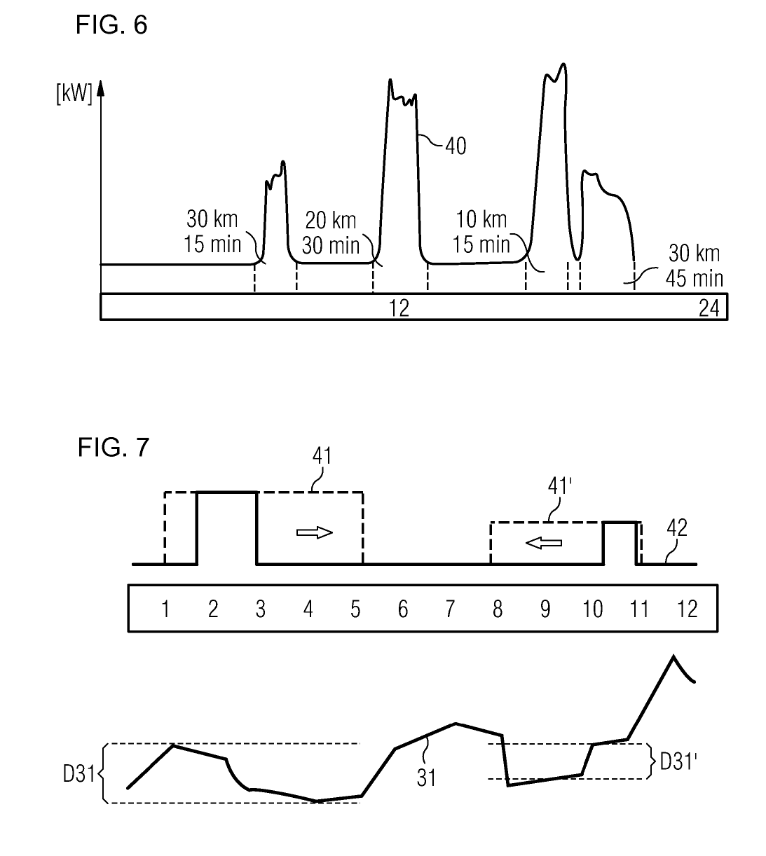

FIG. 6 shows an example of factors affecting the inventive determination of future requirement plans;

FIG. 7 shows an inventive determination of the night (location: home) and morning (location: place of work) charging times taking into account the price information and possible time window;

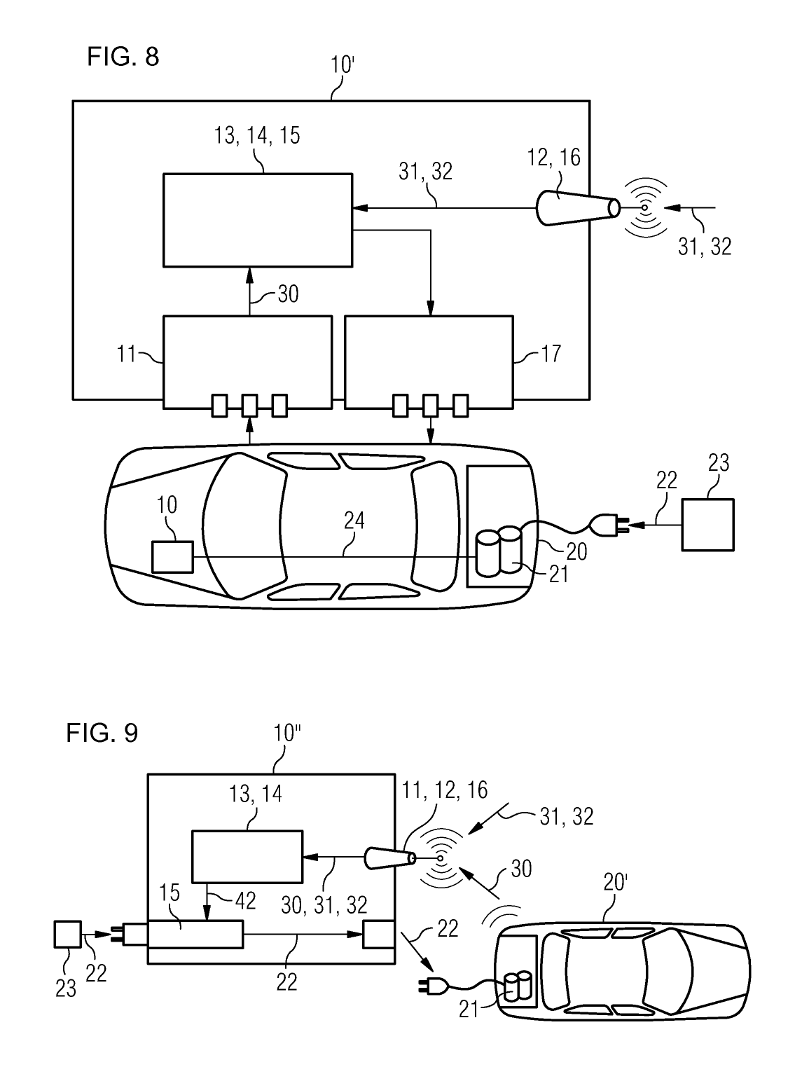

FIG. 8 shows an adapter device according to the invention in a first variant which is implemented as an integral in-vehicle unit, and

FIG. 9 shows an adapter device according to the invention in a second variant which is implemented as an external unit between a power outlet and a vehicle.

FIG. 1 is a bar chart showing the known and forecast sales figures for electric motors in Europe, the USA and Japan in millions of units, plotted over the years 2005 to 2012, as has already been explained in the introduction. This indicates that the market penetration of hybrid vehicles is clearly set to increase.

FIG. 2 shows a graph with characteristic curves C1 to C5 of CO₂ emissions in g/km of a hybrid (Kangoo) and a plug-in hybrid vehicle (Cleanova), plotted over the respective distance traveled in km, as has already been explained in the introduction. The graph shows that plug-in hybrid vehicles have clear advantages over hybrid vehicles, as evidenced by characteristic curves C1 to C3 compared to C4 and C5.

FIG. 3 is a graph showing weekday characteristic curves C6 to C12 of start times of journeys as a function of travel purpose in cumulative curves, as has likewise already been explained in the introduction. The typical start times in the morning are clustered around approximately 07:00, at midday around 12:00 and in the evening around 16:30, which in particular represents the morning and evening journey to/from work.

FIG. 4 shows an inventive adapter device 10 illustrating the basic principle of the method according to the invention. The device 10 will hereinafter also be referred to as the Power Efficient Charging Adapter (PCA).

The device 10 is connected to a vehicle 20 via an interface 11 via which the vehicle's internal operating data 30 is read in. The interface 11 is here designed to be attached to the on-board diagnostic interface of the vehicle 20, but can also be present in any other suitable form. For determining the data 30 by means of embedded sensors, a large number of proprietary protocols and common standards of the individual automobile manufacturers exist. Dedicated in-vehicle bus systems include CAN (Controller Area Network), LIN (Local Interconnect Network), MOST (Media Oriented Systems Transport) and/or FlexRay. OSGi (Open Service Gateway initiative) is also used in the automotive sector as an overarching service-oriented platform. The measurement data acquired is used during running time by driver assistance systems e.g. for traction control by ABS (Antilock Braking System) or ESC (Electronic Stabilization System), but also for subsequent diagnostics and fault repair by authorized workshops. For accessing the available sensor data, the on-board diagnostic interface OBD-11 has been specified in the SAE (Society of Automotive Engineers) Standard J1979. Via the plug and socket connection which is frequently mounted on the driver side in the interior of the vehicle, sensor information can be read out from the vehicle bus in real time and for subsequent diagnostic purposes. A number of parameters (PIDS) are readily accessible, others are only made available to the assistance systems of the vehicle itself for safety reasons. The list includes the following vehicle operating data 30 which is for the most part also made available to the driver via various user interfaces:
(i) Speed, RPM;
(ii) Ambient temperature;
(iii) Steering lock angle, pedal positions and switch settings;
(iv) Running time since startup, distance traveled;
(v) Angle of gradient and centrifugal forces, and
(vi) Energy and fuel levels.

Particularly for the favored CAN bus, a number of tools are available for acquiring and analyzing this data 20. The packages HICO.CAN-USB-2 (USB-CAN Interface) from Emtrion and neoVl FIRE (USB-CAN Interface) from Intrepid Control Systems comprise not only the USB-CAN hardware modules but also comprehensive monitoring software. By linking the already available vehicle operating data 20 with optional positioning by a GPS (Global Positioning System) module, lifestyle-dependent driving habits can be captured and used for subsequent usage pattern recognition.

To allow meaningful analysis, the following data can be recorded during the journey by the on-board sensor system:
(i) Unambiguous identification of the driver and any passengers;
(ii) Characteristic curve of the continuously recorded energy consumption. This is required for subsequent assignment to the route segment data;
(iii) Start time, end time and duration for time categorization of the journey;
(iv) Collected route data such as height profile (uphill grades and downhill grades), kilometers traveled, instantaneous speed over the duration of the drive, etc.;
(v) Current local environmental conditions which can be measured using external sensors, including weather and atmospheric conditions, such as e.g. snow, rain, hail, wetness, icy road conditions, temperature values, etc.;
(vi) Optional position determination by a GPS module, whereby routing and any journey breaks such as intermediate stops and longer period of parking can be recorded, and
(vii) Optionally, the driver's frequency of interaction with the individual controls such as e.g. gearshift lever, brake pedal position and steering wheel, said information concerning frequency, duration and other parameters providing information about the economy of the driving style and therefore likewise contributing to requirement identification.

In addition to the determined vehicle operating data 30 of the on-board sensor system, data sources external to the vehicle can optionally also be used to acquire context information 32 for the requirement calculation. An interface 16 of the device 10 is provided for this purpose. Of relevance here is any information more precisely describing the current situation of the vehicle 20 and affecting its consumption:
(i) Profile data 32′ of the vehicle keeper, such as:
   scheduling in calendar applications which contain information about out of house appointments possibly requiring a car journey. Explicitly entered appointments generally relate to out-of-the-ordinary events which only happen once or a few times. Implicit assumptions as to whereabouts, such as the daily journey to work or the trip to the sports club, are not included, but can be easily recognized autonomously on the basis of frequency, and
   preferred whereabouts such as workplace or educational institution, dwelling zone, locations for leisure activities, etc.
(ii) Traffic information 32″, the critical factors of traffic information affecting requirements being as follows:
   time window of journey, which contributes significantly to the expected traffic density, such as e.g. morning commuter traffic, holiday traffic, etc.;
   assignment to spatial zones, such as e.g. urban area, highway, country road, etc., and
   holdups to be expected, such as e.g. traffic lights, roadworks, temporary road closures, etc.
(iii) Weather information 32′″, as the weather outlook can likewise have an effect on the energy requirement calculation, e.g. if the battery capacity is dependent on ambient temperature, in the case of rain and snow as factors affecting speed and therefore indirectly the requirement.

The requirement identification and planning unit 13 collects the vehicle operating data 30 and the context information 32 and combines the two to produce an energy requirement profile 40 (shown in FIG. 6). For this purpose, factors of lifestyle-dependent driving habits are analyzed and recorded in requirement plans, the characteristic curve of the actual energy consumption of previous journeys providing information about the daily times of journeys and their average duration e.g. in conjunction with the operating times and route data. Idle times 41, 41′ (shown in FIG. 7) of the vehicle 20 are in turn deduced in reverse from the requirements plans. The comparison of duration and frequency of idle times 41, 41′ of the vehicle 20 help to find possible candidates for the best time for charging an energy store, here a battery 21. By means of optional position determination, spatial trip-chaining patterns 43 . . . 43″ (shown in FIG. 5) can be identified and the accuracy of a requirement prediction, defined by daily recurring driving destinations and their sequential order, can be significantly improved. These can be e.g. constantly recurring events such as the weekday journey to work or Saturday shopping in a nearby shopping center. In order to improve the requirement prediction still further, it is optionally possible to link it with the personal profile data 32′, such as e.g. appointments from a calendar application, place of work and residence, leisure activities, etc.

The above mentioned idle times 41, 41′ of the vehicle 20 are then fed to a charging optimization unit 14. Alternatively, of course, the requirement plans themselves can also be fed to said unit 14 and the idle times 41, 41′ finally determined therein. In any case, if all the relevant internal vehicle data 30 and optionally the context information 32 have been incorporated in the requirement plans, by linking in an energy trading platform 50, time- and price-optimized charging plans 42 can be created at the charging optimization unit 14. This assumes a free energy market for end users which is mentioned in various scientific sources and has already been prototyped. With the aid of a forecast of energy price movements 50, the required power quota is purchased at the best possible time within the time window predefined by the requirement.

To include energy offers and price information, two variants for updating the device 10 are provided:

In a first variant, a periodic update takes place in which the device 10 dispenses with a connection to the energy trading platform and only receives an update manually installed by the user via an interface 12 such as e.g. USB and supplied software. The advantage is that the device is less dependent on a possibly unavailable Internet connection, but at the cost of outdated price information. Depending on settings, manual updating can be carried out weekly, monthly or as and when required.

In a second variant, online updating is carried out in which the device 10 has to communicate with a trading platform every time it is connected to the power grid in order to sound out the market to find the best offer currently available. For this purpose, the physical interface 12 to the equipment must be of universal design. A wireless connection such as e.g. IEEE 802.11 WLAN (Wireless Local Area Network) or Bluetooth to the Internet would minimize the cost/complexity of integration into an existing local area network. As the device 10 requires a physical connection to the power grid anyway, communication to the vehicle bus via a power line carrier system would also be conceivable. At protocol level, a TCP/IP-based method such as e.g. web services is preferable.

Following optimization, a calculated charging plan 42 for the vehicle 20 is finally transmitted from the requirement identification and planning unit 13 to a charging control unit 15 which connects a relay of a power supply 22 to the battery 21 of the vehicle 20 depending on the charging plan, the mechanism being similar to a digital timer and preferably being activated as soon as the vehicle 20 is connected to the power grid.

FIG. 5 shows the most frequent day-to-day trip-chaining patterns A, B and C in Vienna, in the Viennese urban fringe in 1995 and in the city of Salzburg in 2004 respectively. Listed here is the probability P of daily occurring trip-chaining patterns which are made up of home (W), work (A), shopping and private (E) and leisure (F) and can also be determined via lifestyle-dependent vehicle use. The total S expresses these trip patterns 43 . . . 43″ as percentage of daily total travel.

FIG. 6 shows an example of factors affecting the inventive determination of future requirement plans. The characteristic curve of an energy requirement profile 40, plotted in kW over the course of a day, shows some of the above mentioned factors such as traffic situation, travel times, distances, purpose and trip-chaining pattern which affect the determination of a future requirement plan. In order to be able to generate future requirement plans of vehicles, the operating data 20 is analyzed using pattern recognition and/or machine learning and/or artificial intelligence methods. Different algorithms can be used depending on the type and composition of the features, including Bayesian networks, hidden Markov models, Bayes classifiers, decision trees, neural networks and support vector machines.

FIG. 7 shows an inventive determination of the night (location: home) and morning (location: place of work) charging times taking account of energy price movements 31 and the possible time window of idle times 41, 41′ of the vehicle 20, plotted over the course of the day, the arrows pointing to the section of the respective window in which, in the light of the predicted energy price movements 31, particularly favorable energy purchase is possible, i.e. optimum charging of the vehicle 20 can take place having regard to quantity and price considerations. A maximum price fluctuation within the respective time window of the idle times 41, 41′ is denoted by D31 and D31′. To make use of the lowest energy price, the charging plan 42 calculated envisions purchasing a large amount of energy at night between approximately 04:00 and 05:00, and purchasing a smaller amount of energy in the morning between approximately 09:00 and 10:00, as the price will have risen again by then. On the other hand, no energy purchase is envisioned during the morning rush-hour between approximately 05:00 and 08:00.

The following two figures show possible variants of an adapter device 10. Depending on technical conditions, other communications interfaces 11, 12 and 16 are required for recording the data 31 on the energy trading platform 50, the data 30 on the vehicle bus system and the context information 32.

FIG. 8 shows an adapter device 10′ according to the invention in a first variant which is implemented as a unit incorporated in the vehicle 20, said adapter constituting a module of the bus system 24 in the vehicle 20. This adapter 10′ is accommodated in the front region of the vehicle 20 and controls a power feed 22 from an external energy source 23, here a power outlet, to its battery 21. The adapter 10′ is shown as a block diagram above the vehicle 20. To record the vehicle operating data, it is mounted on an on-board diagnostic interface 11 of the vehicle 20′. In the event that the vehicle bus does not use a standard interface, another module must be used for control purposes. To record the energy price movements 31 and the context information 32, the interfaces 12 and 16 are implemented as an integrated wireless module. The module is based on the WLAN standard which can communicate with applications in the local area network and also with online services. The data 30, 31 and 32 is fed to an integral requirement identification and planning unit 13, charging optimization unit 14 and charging control unit 15 which generates charging plans 42 for charging the battery 21, the charging process of said battery 21 being controlled via an interface 17 to the bus system of the vehicle 20.

FIG. 9 shows an adapter device 10″ according to the invention in a second variant which is implemented as an external unit between the power outlet 23 and a vehicle 20′, the power feed 22 passing via the adapter 10″ and, in contrast to the embodiment in FIG. 1, being controlled via a separate charging control unit 15. Another difference compared to FIG. 9 are the interfaces 11, 12 and 16 which are incorporated in a wireless module which is again based on the WLAN standard. Said module can communicate both with applications in the local area network and with online services and also with the vehicle bus (not shown). Thus internal vehicle data 30 and context information 32 can be received in the same way as energy price information 31 for the online updating. To calculate the charging plan 42, this data 30, 31 and 32 is transmitted to an integrated requirement identification and planning unit 13 and charging optimization unit 14 which makes it available to the charging control unit 15 for charging the battery 21.

An inventive core element of the power-efficient charging adapter lies in both cases in the development of charging control for electric vehicle batteries, resulting from the combination of two novel and sophisticated components:

On the one hand, a requirement identification and planning unit which uses the vehicle operating data and optional context information obtained by the on-board sensors to find lifestyle-dependent vehicle usage patterns, to calculate the future energy requirement and to record it in requirement plans. On the other hand, the conventional way of purchasing electricity is to enter into a fixed-term contract with a supplier. The user is charged according to fixed day- and night-time tariffs. Electricity suppliers trade with one another on exchanges such as the EEX in order to even out overproductions or deficits in respect of their loads. This can be done on a short-term basis via spot transactions and also longer term via futures transactions, which allows more precise and cost-efficient planning of the production capacities required. This is becoming ever more difficult with the legally mandatory admission of decentralized alternative energy producers, because the production volumes of said producers is often heavily dependent on external circumstances, such as e.g. wind, sun, etc. Many studies have therefore found dynamic electricity prices matched to the current load to be an inescapable future scenario in order to ensure that electricity producers can continue to guarantee supplies. These prices implicitly influence the behavior of electricity consumers and make it predictable, a low electricity price resulting in higher consumption and vice versa, thereby smoothing out loads. Consumers can in turn profit from lower electricity costs through the selective use of their electricity-consuming equipment. These trends show that the electricity market is in a state of upheaval. It must be assumed that, in future, energy markets will be much more flexible and readily accessible even for end customers. Required electricity quotas are purchased on a short-term basis from the cheapest supplier or even bought in advance on the electricity exchange. Enormous savings potentials can therefore flow from intelligent electricity-consuming equipment that is activity- and requirement-oriented.

On the other hand, a charging optimization unit which uses knowledge of the current energy prices and offers to exploit the advantages of a free energy market for end consumers in order to generate optimum battery charging plans in terms of electricity costs and energy-efficient use of the vehicle. This is possible due to the ability to shift the time of electricity purchase within a time frame limited by the requirements. Approaches for modeling in-car electrical energy stores indeed already focus on the optimum use of energy and performance areas and the monitoring of the state of charging and health, an important role being played here not only by chemical and physical properties such as temperature, weight and chemical composition of the energy source, but also the embedding in the overall system for efficient conversion into kinetic propulsion energy. However, intelligent solutions in this area, so-called smart batteries, are limited in design terms to refinements and innovations and do not take into account the subsequent individual use of the electrically powered vehicle. Enhanced energy management, however, is possible for the first time with the present invention which offers a technical method contained in the terminal equipment which is specifically concerned with the efficient and above all lifestyle-related use of battery storage.

The advantages of the proposed solution lie in the energy cost saving for the end consumer compared to conventional charging control for energy stores. Through the possibility of freely selecting an electricity purchasing time within a predefined timeframe, the required energy quotas can be acquired at the best possible price.

Moreover, the implicit and optimized control of the charging process requires minimal user interaction. In the adapter variants with wireless interfaces, once the adapter is installed, it merely suffices to connect the vehicle to a power outlet, as would be necessary anyway.

The method is also robust against exceptional handling of the daily energy consumption and the necessary charging cycles. In the event of low battery charge caused by unforeseeable journeys and not allowing for requirement planning, the user is informed and made aware of unscheduled charging options.

At the same time, a high degree of energy efficiency is achieved by reducing the power loss for the energy producers. As requirement-oriented purchasing on energy trading platforms already presupposes a contractual-legal relationship to the free trade model, the step to a market solution for the integrated, requirement-oriented production of electricity by the communication of individuals' requirement plans is no longer far off. However, due to the market's supply and demand mechanisms and automated purchasing, there will be a smoothing of the load peaks in the power grid even without the communication of precise plans.

The method according to the invention provides an additional sales argument in favor of electric vehicles, and therefore the positioning of electrically powered vehicles as a serious alternative to vehicles with internal combustion engines particularly in the area of short distance trips and urban travel, without having to accept usage limitations due to short battery operating times.

The invention is also suitable as an inexpensive and efficient extension of existing systems which already use vehicle operating data to save energy for electric vehicles. Installing the inventive device as an adapter or integral part of a vehicle could hardly be simpler, placing only minimal requirements in respect of the available interfaces:

(i) There must be an interface to the energy trade in order to carry out the periodic patching of the price information. This merely requires a serial data interface such as e.g. USB or an integral memory card and the updating software. For the frequent online updating, a wireless connection such as e.g. Bluetooth, WLAN etc. of the adapter or a power line connection via the lead to the Internet is necessary if the equipment is installed in the vehicle.

(ii) An interface to the bus system of the vehicle must be present, a connection to the on-board sensors of the vehicle via a wireless connection such as e.g. Bluetooth, WLAN etc. to its bus system being possible in the outside-the-vehicle version of the power efficient charging adapter. When incorporated in the vehicle, the unit can be attached directly to the vehicle bus.

(iii) An interface for optional context information for requirement planning can also be provided, allowing connection to local and online service providers.

(iv) In terms of a flexible model for identifying driving habits, the parts of the requirement identification and requirement planning unit which are involved in recognizing vehicle usage patterns can be used for similar and/or vehicle-related issues. These include e.g. refining the pay-as-you-drive insurance model which can make better calculations using the data concerning the driving style and the driving habits of a vehicle keeper.

1-17. (canceled)

18. An adapter device for charging a vehicle, the adapter device comprising:
an interface for acquiring internal vehicle operating data including factors indicating lifestyle-dependent driving habits;
an interface for acquiring information about energy price movements;
a requirement identification and planning unit configured to deduce an energy requirement profile from the vehicle operating data and to generate a future requirement plan on a basis of at least one of the factors, and further configured to deduce a duration and frequency of idle times of the vehicle using the future requirement plan;
a charging optimization unit for comparing the idle times of the vehicle with the information about energy price movements and to generate at least one of a time-optimized or price-optimized charging plan for the vehicle on a basis of a comparison result; and
a charging control unit for charging an energy store of the vehicle in a manner controlled by the charging plan.

19. The device according to claim 18, further comprising an interface for acquiring context information describing in more detail a current situation of the vehicle and having an effect on consumption, including at least one of profile data of a vehicle owner, traffic information or weather information, and said requirement identification and planning unit is additionally configured to deduce the energy requirement profile from the context information.

20. The device according to claim 19, wherein at least one of said interfaces is configured for wireless acquisition of at least one of the vehicle operating data, the energy price information or the context information.

21. The device according to claim 18, further comprising a memory unit for storing the information concerning energy price movements.

22. The device according to claim 18, wherein the device is an external adapter between an energy source and the energy store of the vehicle.

23. The device according to claim 18, wherein the device is an adapter implemented as an integral part of the vehicle.

24. A method for recognizing vehicle usage patterns, including recognizing driving habits or a driving style for calculating insurance models, which comprises the steps of:
providing an adapter device for charging a vehicle, the adapter device having an interface for acquiring internal vehicle operating data including factors indicating lifestyle-dependent driving habits, an interface for acquiring information about energy price movements, a requirement identification and planning unit configured to deduce an energy requirement profile from the vehicle operating data and to generate a future requirement plan on a basis of at least one of the factors and further configured to deduce a duration and frequency of idle times of the vehicle using the future requirement plan, a charging optimization unit for comparing the idle times of the vehicle with the information about energy price movements and to generate a time-optimized and/or price-optimized charging plan for the vehicle on a basis of a comparison result, and a charging control unit for charging an energy store of the vehicle in a manner controlled by the charging plan; and
generating the vehicle usage patterns via the adaptive device.

25. A method for charging a vehicle, which comprises the steps of:
acquiring and storing internal vehicle operating data containing factors indicating lifestyle-dependent driving habits;
deducing an energy requirement profile from the vehicle operating data and generating a future requirement plan created in dependence on at least one of the factors;
deducing a duration and frequency of idle times of the vehicle using the future requirement plan;
acquiring energy price movements and comparing the idle times of the vehicle with the energy price movements; and
producing a time-optimized and/or price-optimized charging plan for the vehicle on the basis of a comparison result.

26. The method according to claim 25, which further comprises generating the future requirement plan for the vehicle by determining daily travel times and average journey duration from a characteristic curve of an actual energy consumption of journeys made.

27. The method according to claim 26, which further comprises using at least one of operating times or route data to generate the future requirement plan for the vehicle.

28. The method according to claim 25, which further comprises generating the future requirement plan for the vehicle by acquiring positions of the vehicle and deducing therefrom spatial trip-chaining patterns indicating daily recurring destinations and their sequential order.

29. The method according to claim 25, wherein, in order to generate the future requirement plan, context information external to the vehicle is additionally used which describes in greater detail a current situation of the vehicle and has an effect on consumption.

30. The method according to claim 25, wherein, in an event of low charge caused by unforeseeable journeys, a user of the vehicle is given information about unscheduled charging options.

31. The method according to claim 25, which further comprises acquiring the energy price movements by interrogating an Internet-based energy trading platform.

32. The method according to claim 25, which further comprises acquiring the energy price movements by periodically installing a software update.

33. The method according to claim 25, which further comprises activating the charging plan dependently controlled power feed to the vehicle as soon as the latter is connected to an energy source.

34. The method according to claim 25, which further comprises implementing a pattern recognition process, a machine learning process or an artificial intelligence process to generate requirement plans.

35. The method according to claim 25, wherein, in order to generate the future requirement plan, context information external to the vehicle and selected from the group consisting of profile data of a vehicle owner, traffic information, and weather information, is additionally used which describes in greater detail a current situation of the vehicle and has an effect on consumption.
